(19) United States
(12) Patent Application Publication
(10) Pub. No.: US 2007/0152523 A1
(43) Pub. Date: Jul. 5, 2007

(54) Submersible Motor with molded encapsulated stator

(75) Inventor: Russell Bookout, Fort Wayne, IN (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: FRANKLIN ELECTRIC CO., INC., Bluffton, IN (US)

(21) Appl. No.: 11/637,497

(22) Filed: Dec. 12, 2006

Related U.S. Application Data
(60) Provisional application No. 60/749,669, filed on Dec. 12, 2005.

(51) Int. Cl. H02K 1/04; H02K 5/12; H02K 5/16; F04B 17/00

(52) U.S. Cl. 310/87; 310/43; 310/90; 417/423.12

(57) ABSTRACT

A submersible motor is disclosed. The motor comprises a combination stator core/end bell assembly comprising a stator core encapsulated in a polymeric material and a first end bell integrally molded to a first end of the stator core, the stator core having an outer surface and an inner surface defining a stator bore. The motor may further include a rotor disposed within the stator bore, a thrust bearing axially supporting the rotor, and a structural portion to absorb axial loads applied to the stator core by the thrust bearing.

### CROSS-REFERENCE TO RELATED APPLICATIONS

This application claims the benefit of U.S. Provisional Application Ser. No. 60/749,669, filed on Dec. 12, 2005, the entirety of which is incorporated herein by reference.

### FEDERALLY SPONSORED RESEARCH OR DEVELOPMENT

Not Applicable.

### TECHNICAL FIELD

The present invention relates to a submersible motor, such as for use in driving a pump in well bore applications, and more particularly to a submersible motor having a molded encapsulated stator core.

### BACKGROUND OF THE INVENTION

Conventional submersible motors typically include a stator and a rotor. The stator has a stainless steel outer shell in most small submersible motors for water applications. The stainless steel outer shell provides corrosion resistance and provides a load path for the axial thrust loads imposed on the rotor shaft. A wound magnetic core having a cylindrical bore is pressed into the stator shell. Ends of the shell are then welded to respective end caps. A thin, cylindrical metallic liner is inserted into the cylindrical bore of the magnetic core and welded into place to the end caps.

A void space inside the stator may be filled with a hardenable, thermally conductive slurry material. Proper filling of this void space may necessary in some applications in order for the stator to resist submergence pressures which the stator is likely to face in service without distortion.

A bottom end bell typically supports a thrust bearing assembly and a bottom radial bearing. The bottom end bell also provides a space for an equalizing diaphragm to be mounted at the bottom of the motor. Up-thrust and axial shaft retention is provided by an up-thrust bearing that typically bears against the bottom of a bearing mounting boss of an upper end bell.

A splined corrosion-resistant shaft provides a connection to the pump, which is mounted on a top surface of the top end bell. The mounting surface must be perpendicular to the shaft axis of rotation and provide a radial location means that is accurately concentric with the shaft. Studs at the top of the motor provide a means of clamping the base of a pump to the motor.

Ensuring a properly sealed and filled stator in a conventional submersible motor requires a number of production steps, use of expensive materials and processes and considerable labor. Advantages include good sealing and life when properly executed, a proven design, a quality appearance and a robust construction.

However conventional submersible motors are relatively expensive to produce. The potting of the stator is a time consuming process. Consistent sealing of the welds requires constant vigilance. And the metal shell is conducive to scale build-up, which adversely affects motor cooling.

Processes to encapsulate items are known. The encapsulation process is similar to a process used to create a golf ball. Specifically the item to be encapsulated is supported in a mold by movable pins. After the initial filling of the mold, and while the plastic is rigid enough to support the item, the pins are withdrawn and plastic is back-filled into the voids created by the withdrawal of the pins. This yields a seamless encapsulation of the item. An animated illustration of this process can be found at www.encaptech.com/process.html.

A step motor is known having an integral encapsulated stator assembly and end bell. See for example a Pacific Scientific step motor at www.encaptech.com/casehistory_danaher.pdf. See also U.S. Pat. No. 5,806,169. While perhaps acceptable as a step motor, this design would not be acceptable as a submersible motor. For example, this step motor has exposed laminations, which would not be acceptable for submersible applications. Also step motors are typically not subjected to axial thrust loads.

### SUMMARY

According to one aspect of the disclosure, a submersible motor includes a rotor assembly, an encapsulated molded stator assembly substantially surrounding the rotor assembly, and at least one bearing assembly rotatably joining the stator assembly to the rotor assembly. The stator assembly includes an integral, molded-in-place end bell on one end thereof.

According to another aspect of the disclosure, a structural portion is disposed exterior to the stator assembly, wherein the structural portion provides a load path for thrust loads applied to the rotor assembly. The structural portion may have a substantially cylindrical shape and may be constructed from expanded metal. The structural portion may include a plurality of straps extending in a generally longitudinal direction along the outer periphery of the stator assembly. Molded ribs may be provided on the outer periphery of the stator assembly.

According to another aspect of the invention, the at least one bearing assembly is a thrust bearing that is mounted within the molded-in-place end bell.

According to still another aspect of the invention, a method of manufacturing a submersible motor includes encapsulating a rotor assembly in a polymeric material and forming an integral upper end bell with the encapsulating material.

### BRIEF DESCRIPTION OF THE DRAWINGS

FIG. 1 is a diagrammatic perspective view of a molded encapsulated stator assembly for a motor in accordance with a first embodiment of the invention;

FIG. 2 is an enlarged, partially cutaway diagrammatic perspective view of an upper portion of the molded encapsulated stator assembly of FIG. 1;

FIG. 3 is a partially cutaway diagrammatic perspective view of the molded encapsulated stator assembly of FIG. 1, attached to an outer shell;

FIG. 4 an enlarged diagrammatic perspective view of the upper portion of the molded encapsulated stator assembly of FIG. 1, attached to the outer shell and showing a top cover, electrical leads, and studs;

FIG. 5 is a partially cutaway diagrammatic perspective view of a motor in accordance with a second embodiment of the invention;

FIG. 6 is a diagrammatic perspective view of a molded encapsulated stator assembly forming part of the motor of FIG. 5;

FIG. 7 is a diagrammatic perspective view from above the motor of FIG. 5;

FIG. 8 is a diagrammatic perspective view from below the motor of FIG. 5

FIG. 9 is a diagrammatic exploded perspective view from below the motor of FIG. 5;

FIG. 10 is an enlarged diagrammatic exploded perspective view from below, showing portions of the motor of FIG. 5; and

FIG. 11 is a diagrammatic cross-sectional view of an upper portion of a motor in accordance with a third embodiment of the invention.

### DETAILED DESCRIPTION

While this invention is susceptible of embodiments in many different forms, there is shown in the drawings and will herein be described in detail, exemplary embodiments of the invention with the understanding that the present disclosure is to be considered as exemplification of the principles of the invention and is not intended to limit the broad aspect of the invention to the embodiments illustrated.

The present disclosure relates to a submersible motor using a stator which has been encapsulated in an electrically insulating material, such as, for example, a polymer material. Materials suited for encapsulating this type of stator should have low water absorption, good stability in water, high dielectric, low transmission of water, good strength, and low creep under load. The encapsulating material can be a PET material, such as DuPont's Rynite® PET, a PPS material, such as Chevron/Phillip's Ryton® PPS, an LNP material, such as GE's LNP, an epoxy resin, or the like.

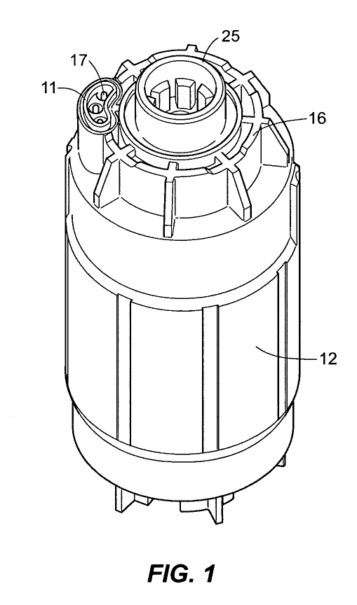

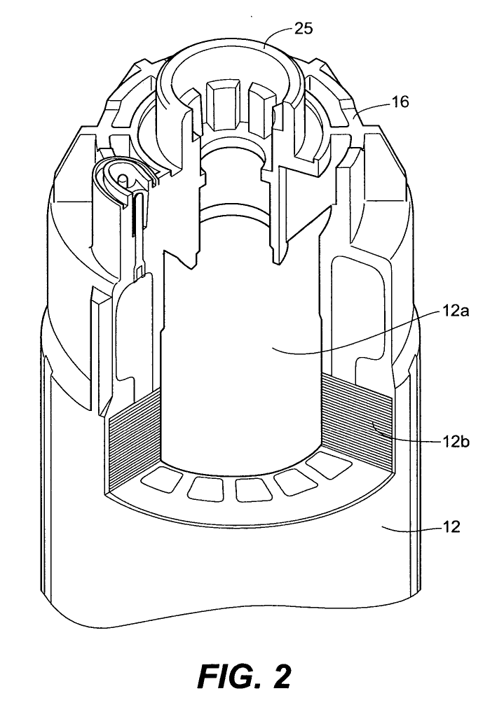

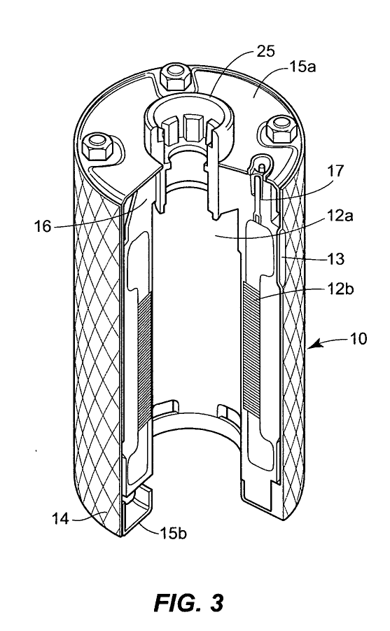

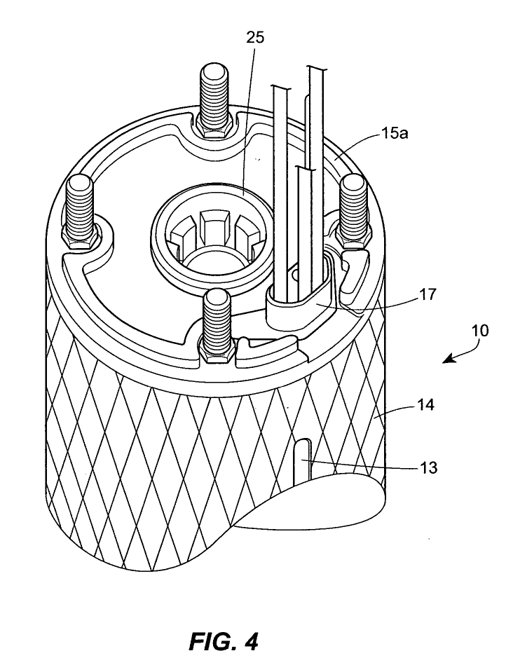

A first embodiment of a motor 10 having a molded, encapsulated stator assembly 12 is illustrated in FIGS. 1-4. The stator assembly 12 has a stator bore 12a for containing a rotor assembly (not shown) and a stator core 12b. The motor 10 may include a shell 14 (FIGS. 3 and 4), that may be made from any material suitable for the environment and capable of providing load-bearing capability for loads encountered by the shell 14 during service and during insertion into a well. However, the shell 14 need not provide a sealing function, because the encapsulating material provides that function. Accordingly, to save weight and material costs, for example, the shell 14 may be made from expanded metal, such as, for example, stainless steel. Other suitable materials for the shell 14 include fiberglass or other types of reinforced plastic materials. The motor 10 may also include end caps 15a and 15b. A liner, not shown, is optional and, if eliminated allows for an integral, molded-in-place end bell on one end of the stator assembly 12. The stator assembly 12 of the motor 10 illustrated in FIGS. 1-4 has an integral, molded-in-place top end bell 16.

As discussed above, end bells are conventionally separate parts from the stator. When the stator assembly 12 incorporates either an integral top end bell 16 or an integral bottom end bell (not shown), production costs can be substantially reduced. Tooling may be utilized which will allow a sleeve bearing to be machined to size and concentric with the stator bore 12a, resulting in better alignment than is possible with conventional slip-fit end bells. Machining of the end bell and stator end to receive the sleeve bearing is eliminated.

It is possible for the sleeve bearing to be the same material as the encapsulant of the stator. However it is preferably insert-molded to allow for material refinement for both the stator and the sleeve bearing. However, the sleeve bearing could also be attached by a snap-fit arrangement or a self-aligning snap-fit arrangement.

A power connector 17, which is conventionally a separate molded part, can be incorporated into the stator material. It is more likely to be a part similar to that conventionally used for manufacturing convenience, only one part (including several connector pins) to insert into the mold rather than multiple connector pins.

Single phase motors requiring a start winding switch may have this optionally molded into the stator, plugged into the stator, or molded into the lead assembly. In conventional submersible motors, it is typically plugged into the stator or molded into the encapsulating material.

Advantages of the motor 10 include simplified construction, reduced machining requirements, reduced production space requirements, a faster production cycle, fewer parts, less material usage, easier achievement of a sealed stator, the requirement of fewer manufacturing personnel and a lower cost of manufacture

The stator core 12b may be inserted into the shell 14. Circulation of a fill solution may be permitted around the stator core 12b inside the shell 14 for improved heat transfer. A flattened lead connection may be provided, rather than a more conventional round configuration. A round lead could be used, but is slightly more complicated to fit in the necessary sealing. Various molded-in features allow the fill solution to circulate around the stator to aid in heat transfer.

An o-ring groove 11 may be provided around the power connector to seal the fill solution in the motor when the lead is removed.

The stator assembly 12 has an integral top end bell 16. The radial sleeve bearing is not shown in place. At the top end of the molded part, a seal would typically be installed with a sand slinger above the seal.

A boss portion 25 of the end bell 16 that projects beyond the upper stator end is the feature that the top cover, which has the pump mounting rabbet, is aligned from, sealed to the end caps to contain the clean lubricating fluid within the motor.

An indention 13 in the shell 14 engages an alignment feature on the molded stator to keep the stator core 12b from rotating with respect to the shell 14, and may be used to align the lead connection with the lead hole in the top stator cover. This may not be required if the plastic chosen is able to maintain a press fit without excessive cold flow and the top cover is placed on after the stator core is pressed into the shell. If there is no press fit, some form of anti-rotation/locating feature will be required.

This same general design could incorporate an expanded metal outer shell with both ends of the molded stator sealed to the end caps to contain the clean lubricating fluid within the motor. The expanded metal outer shell would not only reduce the amount of stainless steel required but would also improve transfer of heat from the motor to the well fluid. A variation would be to use the outer shell for protection, but seal the ends of the bore to keep clean fluid inside the stator and add openings to the stator ends to allow well fluid free access to the area between the stator and shell.

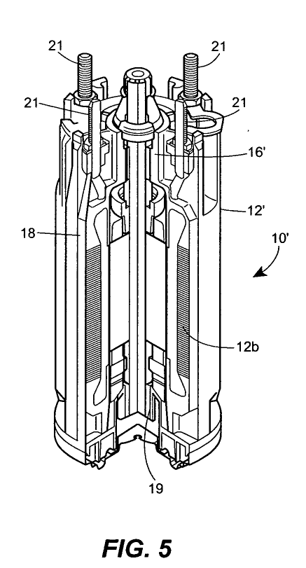

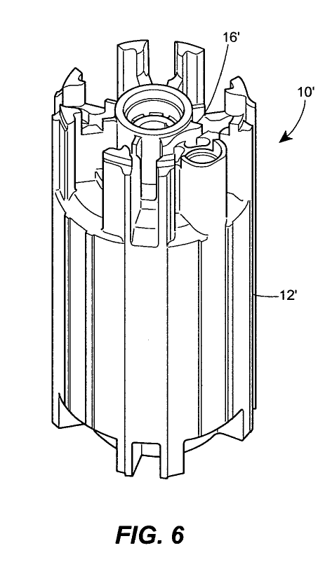

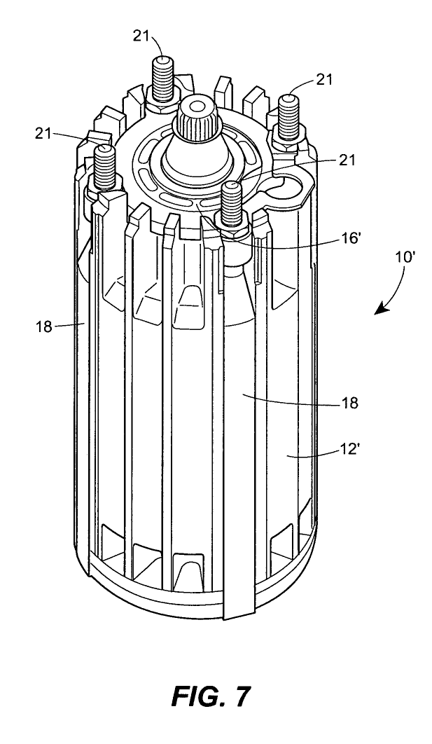

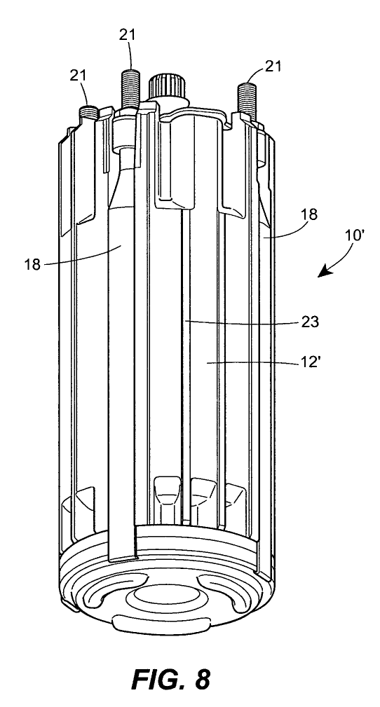

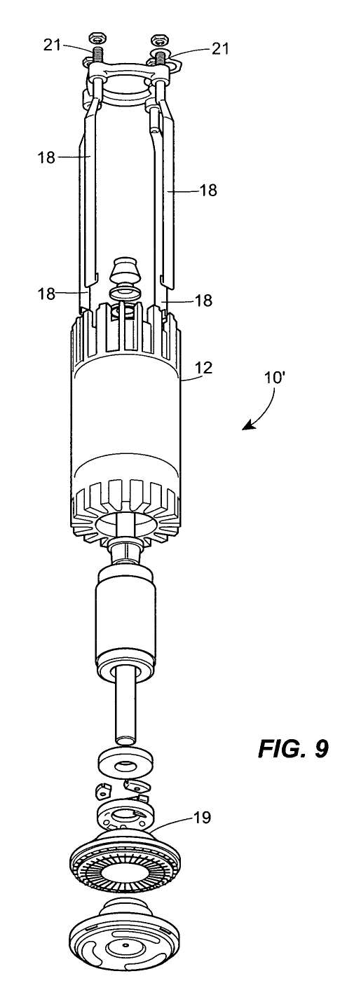

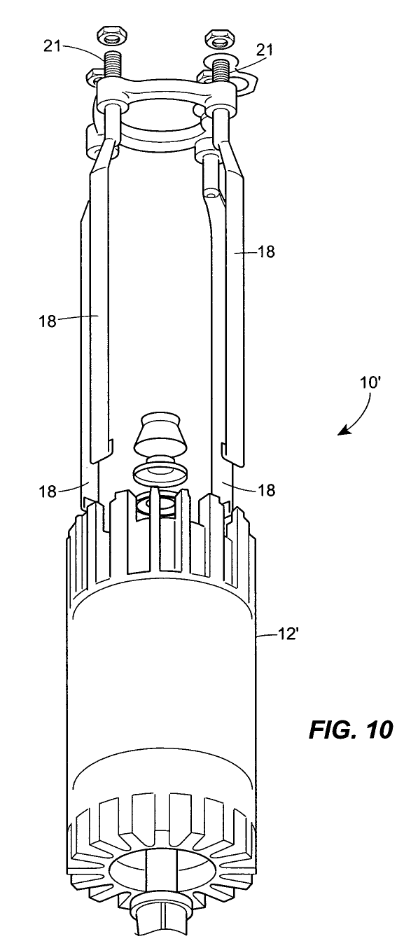

A second embodiment of the motor 10′ is illustrated in FIGS. 5-10, and includes an encapsulated stator assembly 12′ having an integral, molded-in-place end bell 16′. According to the second embodiment of the motor 10′, the shell and stator end caps are eliminated to reduce the amount of corrosion resistant metal. Instead the encapsulating material may be directly exposed to the well fluid, for enhanced cooling due to heat transfer from the encapsulating material to the well fluid.

In one variation of this embodiment, external straps 18 carry any thrust load transmitted to an axial thrust bearing 19 at the bottom of the motor 10′ to upper mounting studs 21. It is also possible to incorporate the intake section of a pump into the molded-in-place end bell 16′. By providing the external straps 18 to bear axial loads, the encapsulating material may have a relatively thin layer between the stator core 12b and the well fluid, to provide less thermal insulation of the stator core 12b and therefore better cooling to the motor 10′. The external straps 18 may be made from any suitable material, such as, for example, corrosion-resistant steel, fabric or fabric reinforced material made from a low creep material such as Vectran Liquid Crystal polymer, etc. Features such as ribs 23 can be molded on the outer surface of the stator to help guide the motor 10′ into the well without damaging the thinner sections on the outer diameter. Intimate contact between the well fluid and the encapsulating material help the motor 10′ to run cooler than if the heat had to be transmitted through an outer shell.

Advantages of the motor 10′ include further minimization of the expensive metal used in conventional submersible motors, improved cooling, improved corrosion resistance, and greater resistance to scale build-up on the outer surface, which build-up can reduce cooling efficiency.

A further variation of the motor 10′ could include a pump intake base in the top end bell 16′ that is already molded-in-place in the stator for a further reduction in the number of parts required to manufacture a motor-pump assembly.

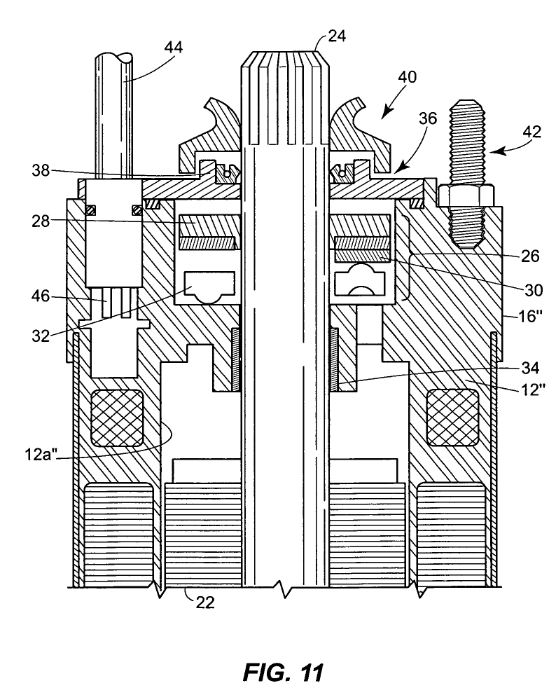

With reference to FIG. 11, a third embodiment of a motor, generally indicated at 10″ includes an encapsulated stator assembly 12″ having an integral top end bell 16″. A rotor assembly 22 is disposed in a stator bore 12a″ and includes a motor shaft 24 mounted to the top end bell 16″ via a thrust bearing assembly 26. A thrust collar 28 is fixedly attached to the motor shaft 24 for rotation therewith.

The thrust bearing assembly 26 may include a bearing shoe or pad 30, that engages a leveling system 32. A top shaft bearing 34 may be disposed below the thrust bearing assembly 26, and a cover plate 36, a shaft seal 38, and a sand slinger 40 may be disposed above the thrust bearing assembly 26.

Since the thrust bearing assembly 26 is located within the top end bell 16″, this decreases the axial load on the encapsulated stator assembly 12″ sufficiently for the encapsulated stator assembly 12″ to support its own load, without the need for a shell or straps to take up axial loads. Studs 42 may be anchored within the encapsulating material, for example, using threaded inserts (not shown), and may be used to secure the motor 10″ to a pump (not shown). A power cable 44 may connect to connector elements 46 that are molded into the encapsulating material.

While specific embodiments have been illustrated and described, numerous modifications may come to mind without significantly departing from the spirit of the invention, and the scope of protection is only limited by the scope of the accompanying claims. For example, the external straps 18 could also be used to hold the pump and motor together—straps could stretch from the pump discharge on one side, around under the motor to the other side of the pump discharge. Two or three of these straps could provide the strength needed for a small residential pump.

What is claimed is:

1. A submersible motor comprising:
a rotor assembly;
an encapsulated molded stator assembly substantially surrounding the rotor assembly; and
at least one bearing assembly rotatably joining the stator assembly to the rotor assembly;
wherein, the stator assembly includes an integral, molded-in-place end bell on one end thereof.

2. The submersible motor of claim 1, further including a structural portion disposed exterior to the stator assembly, wherein the structural portion provides a load path for thrust loads applied to the rotor assembly.

3. The submersible motor of claim 2, wherein the structural portion has a substantially cylindrical shape and is constructed from expanded metal.

4. The submersible motor of claim 2, wherein the structural portion includes a plurality of straps extending in a generally longitudinal direction along the outer periphery of the stator assembly.

5. The submersible motor of claim 4, further including molded ribs on the outer periphery of the stator assembly.

6. The submersible motor of claim 1, wherein the at least one bearing assembly is a thrust bearing that is mounted within the molded-in-place end bell.

7. A method of manufacturing a submersible motor, the method comprising:
encapsulating a rotor assembly in a polymeric material; and
forming an integral upper end bell with the encapsulating material.

8. The method of claim 7, further including installing a bearing assembly within the integral upper end bell.

9. The method of claim 7, further including attaching a load-bearing outer sleeve to the outer periphery of the encapsulated rotor assembly.

10. The method of claim 9, wherein the load-bearing outer sleeve is made from expanded metal.

11. The method of claim 7, further including attaching a load-bearing strap assembly to the outer periphery of the encapsulated rotor assembly.

12. The method of claim 1 1, wherein load-bearing the strap assembly includes a plurality of metal straps.

13. The method of claim 11, wherein the load-bearing strap assembly includes a plurality of fabric straps.

14. he method of claim 11, wherein the load-bearing strap assembly includes a plurality of fabric reinforced straps.

15. The method of claim 11, further including forming a plurality of longitudinal ribs on the outer periphery of the encapsulated rotor assembly.

16. The method of claim 7, further including forming a plurality of longitudinal ribs on the outer periphery of the encapsulated rotor assembly.
